(19) United States
(12) Patent Application Publication
(10) Pub. No.: US 2011/0183693 A1
(43) Pub. Date: Jul. 28, 2011

(54) BASE STATION DEVICE AND MOBILE COMMUNICATION SYSTEM

(75) Inventor: Fumiki Hasegawa, Tokyo (JP)

(73) Assignee: MITSUBISHI ELECTRIC CORPORATION, Tokyo (JP)

(21) Appl. No.: 12/918,441

(22) PCT Filed: Mar. 6, 2008
(86) PCT No.: PCT/JP2008/000467

§ 371 Date: Aug. 19, 2010

(51) Int. Cl. H04B 7/24

(52) U.S. Cl. 455/507

(57) ABSTRACT

When receiving an inquiry about whether allocation of a mobile communication device can be made from an arbitrary base station device, a handover control unit 20 records the number of times that a handover has been carried out for the arbitrary base station device. When receiving an inquiry about whether allocation can be made from another base station device, a control enable or disable determining unit 30 determines that the allocation can be made if the number of handover times recorded for the other base station device in the handover control unit 20 is smaller than a predetermined value and the base station itself can satisfy a throughput which the mobile communication device requests.

### FIELD OF THE INVENTION

The present invention relates to a base station device that can set a maximum throughput which a moving communication device requests, and a mobile communication system equipped with the base station device.

### BACKGROUND OF THE INVENTION

In a conventional mobile communication system (e.g., a 3G radio access network), a base station control device receives a radio wave condition report from a moving communication device (the base station control device receives information from the moving communication device via a base station device), and takes the initiative to issue a command to the moving communication device (for example, refer to patent reference 1).
[Patent reference 1] JP,8-154269,A

In a next-generation radio access system, because it is scheduled that a control function is incorporated into a base station device, the base station device needs to take the initiative to carry out control of a neighboring base station device and a moving communication device. However, no technology of making such base station devices transmit and receive control information between them so as to carry out allocation of a moving communication device has been established.

The present invention is made in order to solve the above-mentioned problem, and it is therefore an object of the present invention to provide a base station device and a mobile communication system that can control a moving communication device satisfactorily.

### DESCRIPTION OF THE INVENTION

A base station device in accordance with the present invention is configured in such a way as to, when receiving an inquiry about whether or not allocation of a mobile communication device can be made from another base station device, determine that the allocation can be made if the number of handover times for the other base station is smaller than a predetermined value. As a result, the base station device can carry out control the moving communication device satisfactorily even if the mobile communication device is located under wrong radio wave conditions.

### BRIEF DESCRIPTION OF THE FIGURES

FIG. 1 is a block diagram showing a base station device in accordance with Embodiment 1 of the present invention;

FIG. 2 is a hardware configuration view of the base station device in accordance with Embodiment 1 of the present invention;

FIG. 3 is an explanatory drawing showing a mobile communication system in accordance with Embodiment 1 of the present invention;

FIG. 4 is a flow chart showing a communication channel setting process carried out by the base station device in accordance with Embodiment 1 of the present invention;

FIG. 5 is a flow chart showing an operation at the time of receiving an allocation inquiry message which is carried out by the base station device in accordance with Embodiment 1 of the present invention;

FIG. 6 is an explanatory drawing showing the operation of a mobile communication system in accordance with Embodiment 2 of the present invention;

FIG. 7 is a flow chart showing a concrete control method of complementing a service area which the mobile communication system in accordance with Embodiment 2 of the present invention uses; and

FIG. 8 is a block diagram showing a base station device in accordance with Embodiment 3 of the present invention.

### PREFERRED EMBODIMENTS OF THE INVENTION

Hereafter, in order to explain this invention in greater detail, the preferred embodiments of the present invention will be described with reference to the accompanying drawings.

### Embodiment 1

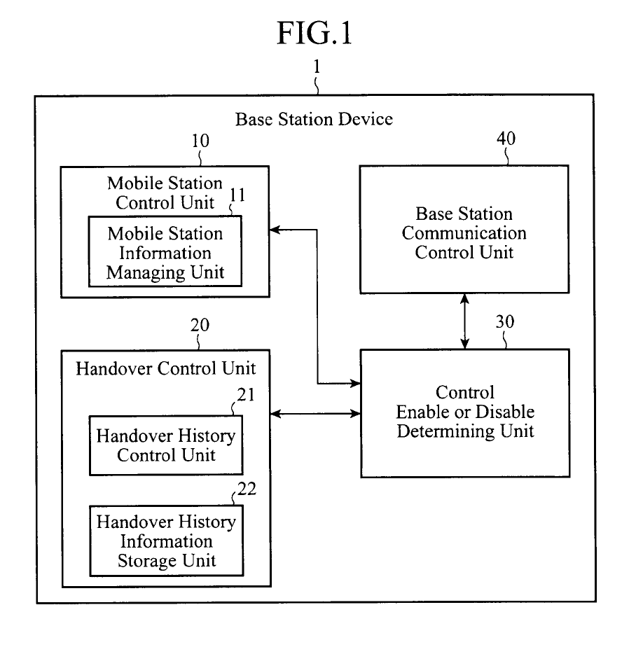

FIG. 1 is a block diagram showing a base station device in accordance with Embodiment 1 of the present invention.

The base station device 1 shown in the figure is provided with a mobile station control unit 10, a handover control unit 20, a control enable or disable determining unit 30, and a base station communication control unit 40. The mobile station control unit 10 controls a mobile communication device, and is provided with a mobile station information managing unit 11. The mobile station information managing unit 11 is a functional unit for storing and managing various pieces of information about the mobile communication device. The handover control unit 20 carries out control of a handover of the base station device, and has a handover history control unit 21 and a handover history information storage unit 22. The handover history control unit 21 controls the time at which to store a handover history, and so on, and the handover history information storage unit 22 stores handover history information. The handover history information has elements for each of neighboring service areas, and the elements of each of the neighboring service areas include a cause resulting in a handover from the neighboring service area, resource conditions of the neighboring service area which is a handover source, and the radio wave conditions of the mobile communication device at the time of performing a handover operation.

When receiving an inquiry about whether or not allocation of a mobile communication device to the base station device itself can be made from another base station devices via the base station communication control unit 40, the control enable or disable determining unit 30 determines whether the base station device itself can control the mobile communication device on the basis of whether or not the handover history managed by the handover control unit 20 is equal to or smaller than a predetermined number of times. The base station communication control unit 40 carries out control of communications with another base station device.

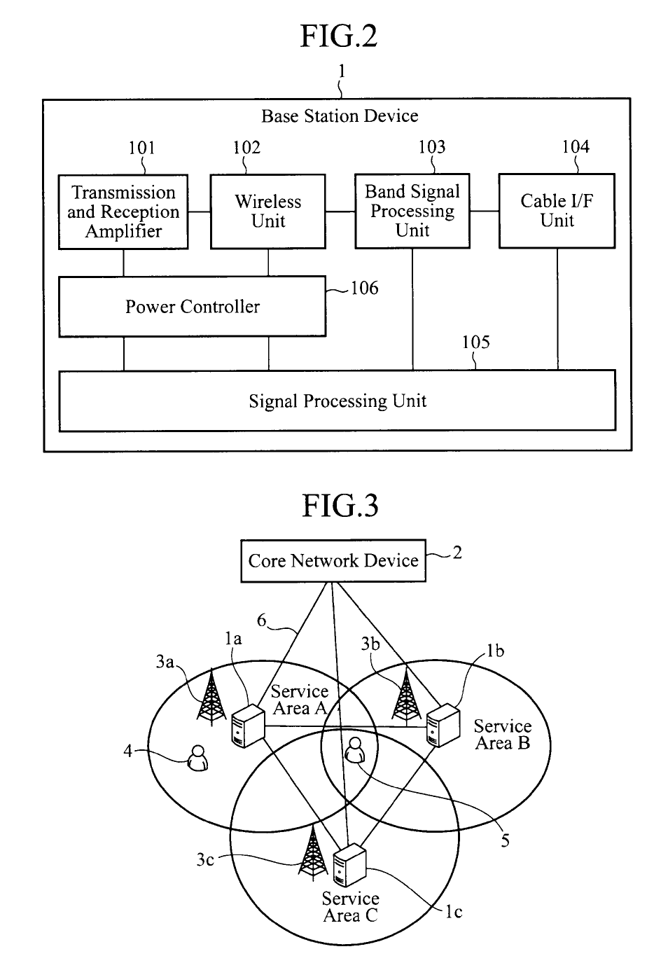

FIG. 2 is a view showing the hardware configuration of the base station device 1. As shown in the figure, the base station device 1 is provided with a transmission and reception amplifying unit 101, a wireless unit 102, a base band signal processing unit 103, a cable I/F unit 104, a signal processing unit 105, and a power controller 106. The transmission and reception amplifying unit 101 is an amplifying unit for carrying out a process of amplifying a radio signal, the wireless unit 102 is a processing unit for processing the radio signal, and the baseband processing unit 103 is a processing unit for processing a baseband signal. The cable I/F unit 104 is an interface for making a cable communication connection with another base station device 1 or the like. The signal processing unit 105 is a processing unit for processing a signal common to the wireless unit and a wired unit. The power controller 106 is a control unit for controlling communication electric power. In this case, the mobile station control unit 10 in FIG. 1 is implemented mainly by the transmission and reception amplifying unit 101, the wireless unit 102, the signal processing unit 105, and the power controller 106. The handover control unit 20 and the control enable or disable determining unit 30 are implemented by the signal processing unit 105, and the base station communication control unit 40 is implemented by the cable I/F unit 104 and the signal processing unit 105.

FIG. 3 is an explanatory drawing of the mobile communication system in accordance with Embodiment 1 of the present invention.

The mobile communication system shown in the figure is an example which consists of three base station devices 1a, 1b, and 1c and a core network device 2. Each of the base station devices 1a, 1b, and 1c has the configuration of the base station device 1 explained with reference to FIGS. 1 and 2, and the base station devices have transmit/receive antennas 3a, 3b, and 3c and form service areas A, B, and C respectively. In a state shown in the figure, it is assumed that a user (a mobile communication device) 4 is located in the service area A, and a user (a mobile communication device) 5 is located in an area in which the service areas A, B, and C overlap one another. In addition, the base station devices 1a, 1b, and 1c and the core network device 2 are communication-connected to one another via wire circuits 6.

Next, the operation of the mobile communication system in accordance with Embodiment 1 will be explained.

First, the time when handover history information is stored will be explained.

In the state of FIG. 3, the user 4 carries out a handover process when moving from the service area A to the service area B, while the base station device 1a which receives a command from the user 4 at that time notifies the base station devices 1b and 1c whose service areas are neighboring to the service area thereof that the user 4 has carried out the handover process. The notification includes the service area information about the movement source, the service area information on the movement destination, the reason for the movement, and the radio wave receiving state of the mobile communication device.

Each of the base station devices 1b and 1c receives the notification of the handover process from the base station device 1a and stores the notification as a handover history. When each of the base station devices stores the history, the handover history control unit 21 of each of the base station devices increments the number of handover times stored in the handover history information storage unit 22. After that, the handover history control unit 21 increments the number of handover times stored in the handover history information storage unit 22 every time when each of the base station devices receives a notification of the handover process. Initialization of the handover history information storage unit 22 is carried out at the time of occurrence of a timeout of a predetermined timer, or at the time when the base station device itself is initialized. A notification of a message among the base station devices 1a, 1b, and 1c is made directly among them or via the core network device 2.

Next, a communication channel setting process carried out by each of the base station devices 1a, 1b, and 1c will be explained.

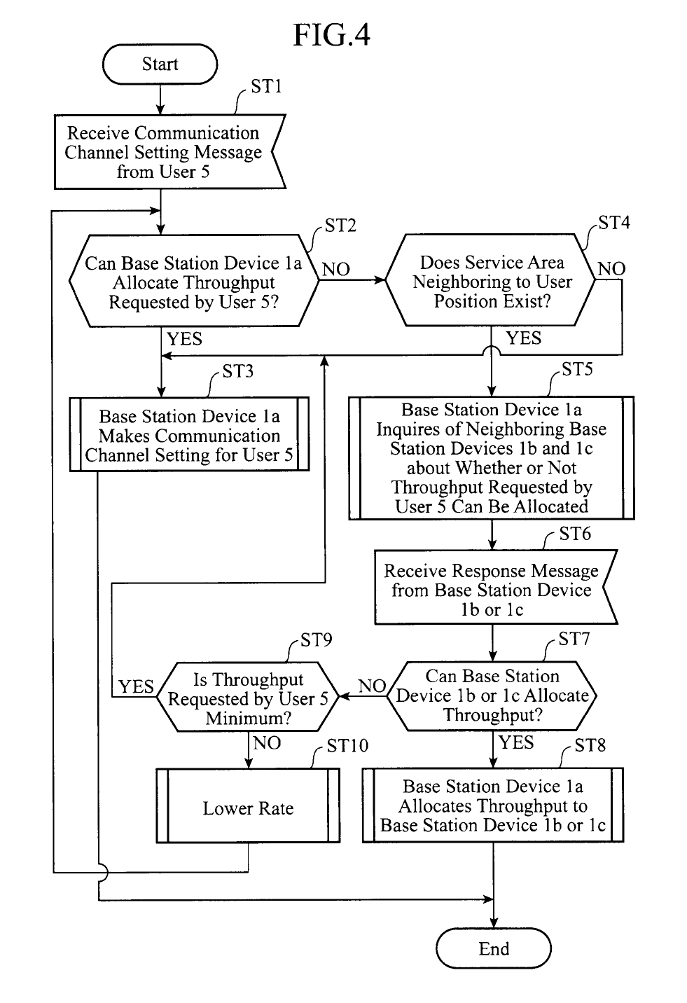

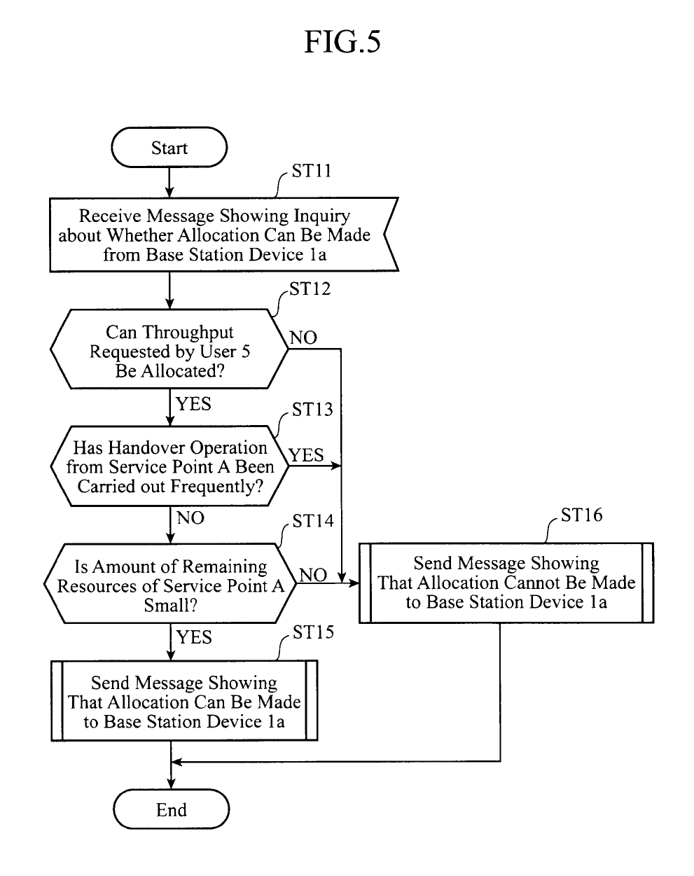

FIG. 4 is a flow chart showing the communication channel setting process, and shows a case in which the control enable or disable determining unit 30 in the base station device 1a makes a communication channel setting for the user 5 (a channel setting in the service area A).

The control enable or disable determining unit 30 of the base station device 1a which, in step ST1, has received a notification of a first signal in the communication channel setting process, in step ST2, determines whether or not a throughput setting which the user 5 requests (i.e., a data rate which the user requests) can be made. A criterion of the determination is a resource condition of the base station device.

More specifically, when a relation between the number of available codes required for a call setup in the base station device and the number of codes required for the call setup meets “the number of available codes+α>the number of codes required for the call setup”, the control enable or disable determining unit determines that allocation can be made. α can be set to the criterion of the determination in order to prevent the number of available codes from becoming zero, and is therefore defined as a system parameter which can be changed. When the results of the determination show that allocation can be made, the base station device 1a, in step ST3, controls the user 5.

In contrast, when the results of the determination show that no allocation can be made, the base station device, in step ST4, determines whether or not there exists an service area neighboring to the position of the user 5 who is going to set a communication channel. The neighboring service area shows the position of the user 5 of FIG. 2, and shows a point where the service areas of the base station devices 1a, 1b, and 1c overlap one another.

When the results of the determination of step ST4 show that no neighboring service area exists, the control enable or disable determining unit 30 makes a transition to step ST3 and then determines that the base station device should control the user by itself. More specifically, the base station device 1a controls the user 5. In contrast, when the results of the determination of step ST4 show that a neighboring service area exists, the base station device 1a, in step ST5, inquires of each of the adjacent base station devices 1b and 1c about whether or not allocation can be made. More specifically, the control enable or disable determining unit 30 transmits an inquiry message indicating whether or not allocation can be made to each of the base station devices 1b and 1c via the base station communication control unit 40.

After, in step ST5, transmitting the inquiry message to each of the adjacent base station devices 1b and 1c, the control enable or disable determining unit 30, in step ST6, receives a response to the inquiry from the base station device 1b or 1c. The control enable or disable determining unit, in step ST7, checks the notification of step ST6, and, when determining that the notification shows that allocation to the base station device 1b or 1c can be made, in step ST8, carries out a process of allocating the control of the user 5 to the base station device 1b or 1c. In contrast, when, in step ST7, determining that the notification shows that allocation to the base station devices cannot be made, the control enable or disable determining unit 30, in step ST9, determines whether or not the throughput which the user 5 requests is a minimum. When the throughput which the user requests is not a minimum, the control enable or disable determining unit lowers the rate (step ST10) and carries out step ST2 and subsequent steps in the flow.

When, in step ST6, receiving response messages from both the base station devices 1b and 1c, and then, in step ST7, determining that the response messages show that allocation to any of both the base station devices 1b and 1c can be made, the control enable or disable determining unit 30 selects one of the base station devices which has transmitted the response message to the base station device 1a at an earlier time as a user-allocated base station.

Next, the operation of each of the base station devices which has received the allocation inquiry message will be explained.

FIG. 5 is a flowchart showing the operation of the control enable or disable determining unit 30 in each of the base station devices which has received the allocation inquiry message.

The inquiry message from the base station device 1a includes the following pieces of information (1) to (4).

(1) Code information required for the call setup for the mobile communication device
(2) Information required for the call setup including the type of the mobile communication device, and the terminal capability which the mobile communication device has
(3) Remaining resource information regarding the call setup by the base station devices 1a including the remaining resource of the base station device 1a
(4) Information about the base station devices neighboring to the base station device 1a

The control enable or disable determining unit, in step ST11, receives the inquiry message from the base station device 1a and determines whether the throughput (data rate) which the user 5 requests in step ST12 can be allocated. When, as a result of the determination, determining that the throughput can be allocated, the control enable or disable determining unit, in step ST13, determines whether or not a handover from a service point A at which the user 5 is going to make a communication channel setting has been carried out frequently on the basis of the handover history stored in the device. The service point A shows a point where the service area A is implemented, i.e., the logical position of the base station device 1a.

For example, whether or not a handover from the service point A has been carried out frequently is determined according to whether the number of times that one user has performed a handover reaches three times. When the number of times that one user has performed a handover is equal to or larger than three times, it is defined that a handover from the service point A has been carried out frequently. This definition can be changed by using a system parameter setting which the base station device has therein.

Criteria for the determination of step ST13 can include, as a first-priority criterion, the number of times that the user has performed a handover, and additionally include either one of the number of times that a handover has occurred in a unit time, the reason for the movement, and the radio wave conditions of the mobile communication device. Furthermore, the priorities assigned to the two criteria can be interchanged. In addition, some or all of the above-mentioned criteria can be combined. When the results of the determination of step ST13 show that the criterion is satisfied, because the control enable or disable determining unit can determine that the area in which the user 5 is located is in an unstable state, the control enable or disable determining unit makes a notification indicating that allocation of the mobile communication device cannot be made in such a way as to return the control of the mobile communication device to the base station device which has controlled the mobile communication device until then from the viewpoint of suppressing the excessive handover process (step ST16).

In contrast, when the criterion is not satisfied in step ST13, i.e., when the number of times that the user has performed a handover is smaller than three times, the control enable or disable determining unit, in step ST14, determines the remaining resource condition of the service point A. A criterion for the determination of the remaining resource condition is whether or not the amount of available resources, such as available channels, is a certain percentage, e.g., 10% of the whole resources which the base station device has, and, when the amount of available resources is equal to or less than 10%, the control enable or disable determining unit determines that the remaining resource amount is small. The control enable or disable determining unit can change the threshold according to the circumstances.

When the results of determination of step ST14 show that the amount of remaining resource of the service point A is small, the control enable or disable determining unit determines that it is more effective to continue the service using the base station device 1b which manages the service point B rather than to control the mobile communication device by using the service point A from the viewpoint of the continuation of the service, and sends a message showing that allocation can be made to the base station device 1a.

When, in step ST12, determining that the throughput which the user 5 requests cannot be allocated, when, in step ST13, determining that the handover has been carried out frequently, or when, in step ST14, determining that the amount of remaining resource of the service point A is not small, the control enable or disable determining unit, in step ST16, sends a message showing that allocation cannot be made to the base station device 1a.

As mentioned above, the base station device in accordance with Embodiment 1 includes the handover control unit for, when receiving an inquiry about whether or not allocation of a moving communication device can be made from an arbitrary base station device, recording the number of times that a handover has been carried out for the arbitrary base station device, and the control enable or disable determining unit for, when receiving an inquiry from another base station device and the recorded number of times that a handover has been carried out for the other base station device is lower than a predetermined value, determining that allocation can be made. Therefore, the base station device in accordance with Embodiment 1 can carry out control the moving communication device satisfactorily even if the mobile communication device is located under wrong radio wave conditions.

Furthermore, in the base station device in accordance with Embodiment 1, the control enable or disable determining unit determines whether or not the throughput can be satisfied when receiving a call setup request from the moving communication device, and, when the throughput can be satisfied, that the base station device itself can control the moving communication device, whereas when the throughput cannot be satisfied, the control enable or disable determining unit inquires of a neighboring base station device about whether allocation can be made. Therefore, the base station device can provide the throughput which the mobile communication device requests.

In addition, because the base station device in accordance with Embodiment 1 makes information showing whether the throughput can be satisfied include information about available channels, the base station device can ensure allocation of the mobile communication device.

Furthermore, because the mobile communication system in accordance with Embodiment 1 includes a plurality of base station devices, and switches control of a moving communication device from a base station device which has inquired about whether or not allocation can be made to another base station device which has determined that allocation can be made, the mobile communication system can dynamically rearrange the resource amounts of the service areas among the base station devices according to the traffic conditions.

### Embodiment 2

A base station device in accordance with Embodiment 2 is configured in such a way as to, when receiving a notification showing uncontrollable from another base station device 1 which is controlling a mobile communication device located outside the service area of the other base station device, raise its radio wave output to carry out an area complement, and then control the mobile communication device.

Because the configuration of each base station device in terms of drawings is the same as that shown in FIGS. 1 and 2, the configuration will be explained with reference to these drawings. A control enable or disable determining unit 30 in accordance with Embodiment 2 is configured in such a way as to, when receiving a notification indicating that allocation of a mobile communication device cannot be made from another base station device 1, notify the other base station device 1 that allocation of the mobile communication device can be made if there is a predetermined amount or more of available resources, the mobile communication device can be positioned within the service area because of increase in the radio wave output, and the number of times that a handover from the other base station has been carried out is lower than a predetermined value. Because the other configuration of the base station device is the same as that of Embodiment 1, the explanation of the other configuration will be omitted hereafter.

Next, the operation of a mobile communication system in accordance with Embodiment 2 will be explained.

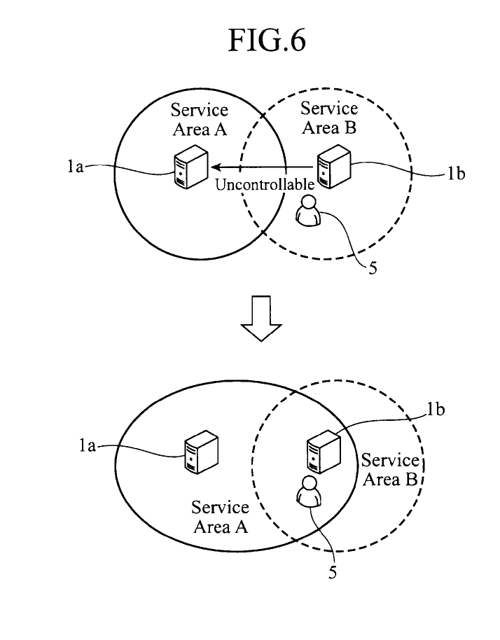

FIG. 6 is an explanatory drawing showing the operation of Embodiment 2.

When receiving a notification indicating that a user (a mobile communication device) 5 is uncontrollable from a neighboring base station device 1b, a base station device 1a expands its service area and determines whether or not the base station device 1a can control the user 5. It is assumed that the user 5 is located outside the service area of the base station device 1b, and has been controlled by the base station device 1b. Furthermore, uncontrollable which is described in this embodiment shows either a state in which it is impossible to make user allocation due to a resource shortage in the base station device, or a state in which it is impossible to carry out a call setup for the user, such as a state in which it is impossible to make user allocation due to occurrence of a failure in the base station device.

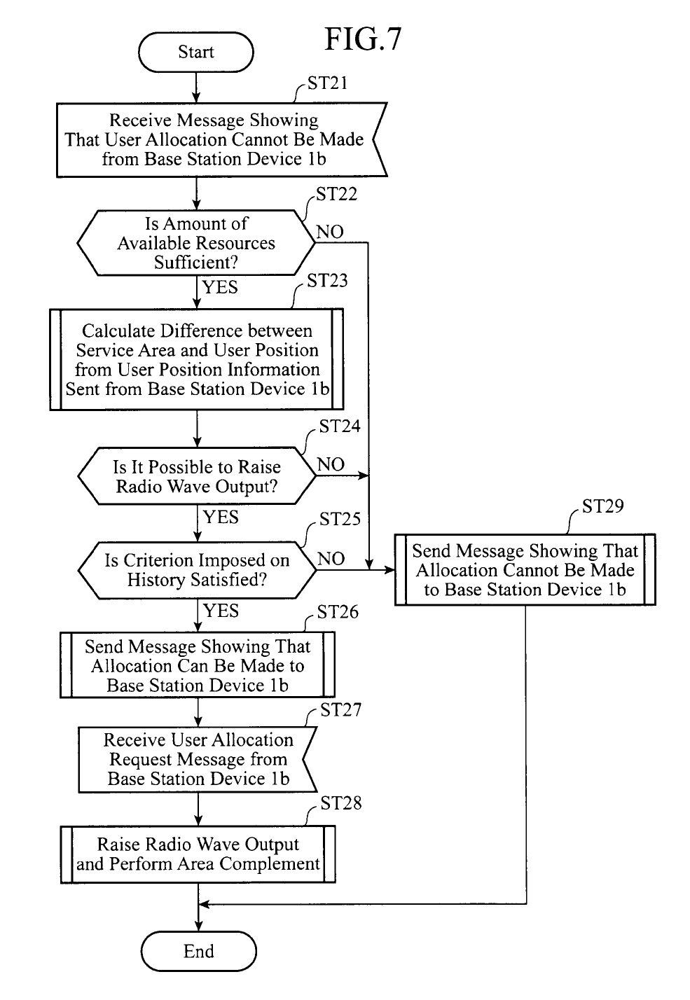

The base station device 1a carries out the determination of whether or not the base station device can control the user according to whether or not there is an amount of resources required for the call setup for the user. When there is an amount of available resources required for the call setup and a criterion imposed on a handover history is satisfied, the base station device 1a determines that the user is controllable, raises its radio wave output, and complements the service area. A definition of the criterion being satisfied will be explained with reference to a flow chart of FIG. 7.

FIG. 7 is a flow chart showing a concrete control method of complementing the service area.

When the base station device 1a, in step ST21, receives a message indicating that user allocation cannot be made from the base station device 1b, the control enable or disable determining unit 30, in step ST22, determines whether or not there is a sufficient amount of available resources. A criterion for the determination of whether or not there is a sufficient amount of available resources is whether or not the amount of available resources is a certain percentage, e.g., 10% of the whole resources which the base station device has, and, when the amount of available resources is equal to or less than 10%, the control enable or disable determining unit determines that the amount of available resources is not sufficient. The control enable or disable determining unit can change the threshold according to the circumstances.

When, in step ST22, determining that the amount of available resources is not sufficient, the control enable or disable determining unit 30 sends a message indicating that user allocation cannot be made to the base station device 1b via a base station communication control unit 40. When the results of the determination in step ST22 show that a sufficient amount of resources is available, the control enable or disable determining unit, in step ST23, calculates the difference between the service area and the user position on the basis of user position information sent thereto from the base station device 1b.

Next, the base station device, in step ST24, determines whether or not it is possible to raise the radio wave output on the basis of the result calculated in step ST23. A power controller 106 and a signal processing unit 105 in the base station device carry out the determination. When the results of the determination of step ST24 show that it is impossible to raise the radio wave output, the base station device sends a message indicating that allocation cannot be made to the base station device 1b (step ST29). When the results of the determination of step ST24 show that it is possible to raise the radio wave output, the base station device, in step ST25, determines whether or not the criterion imposed on the history is satisfied. Criteria of the determination include the total number of times that a handover has occurred during a predetermined time interval, the number of times that a handover has occurred in a unit time, the reason for the movement, and the radio wave conditions of the mobile communication device. The base station device can carry out the determination by using one of these criteria or a combination of some or all of the criteria. In a case in which the total number of times that a handover has occurred during a predetermined time interval is used as the criterion of the determination, when, for example, the total number of handover times >=3, the base station device determines that the area in which the terminal is located is unstable, and determines to delegate the control of the terminal to another base station device and, in step ST29, sends a message indicating that allocation cannot be made to the base station device 1b.

When, in step ST25, determining that the criterion imposed on the history is satisfied, the base station device, in step ST26, sends a message showing that allocation can be made to the base station device 1b. As a result, when, in step ST27, receiving a user allocation request message from the base station device 1b, the base station device, in step ST28, raises its radio wave output to perform an area complement.

Because a handover process that the base station device performs in response to the request from the user is the same as that in accordance with Embodiment 1, the explanation of the process will be omitted hereafter.

As mentioned above, in the base station device in accordance with Embodiment 2, the control enable or disable determining unit is configured in such a way as to, when receiving a notification indicating that the allocation of a mobile communication device cannot be made from another base station device, notify the other base station device that the allocation of the mobile communication device can be made if there is a predetermined amount or more of available resources, the mobile communication device can be positioned within the service area because of increase in its radio wave output, and the number of times that a handover from the other base station has been carried out is lower than a predetermined value. Therefore, the base station device can surely control the mobile communication device.

Furthermore, because the mobile communication system in accordance with Embodiment 2 includes a plurality of base station devices, and switches control of a moving communication device from a base station device to which no allocation can be made to another base station device which has determined that allocation can be made, the mobile communication system can surely control the mobile communication device even when there is a base station device in the mobile communication system which cannot control the mobile communication device.

### Embodiment 3

Embodiment 3 is an example in which the area complement shown in Embodiment 2 is carried out on the basis of heartbeat control between neighboring base station devices.

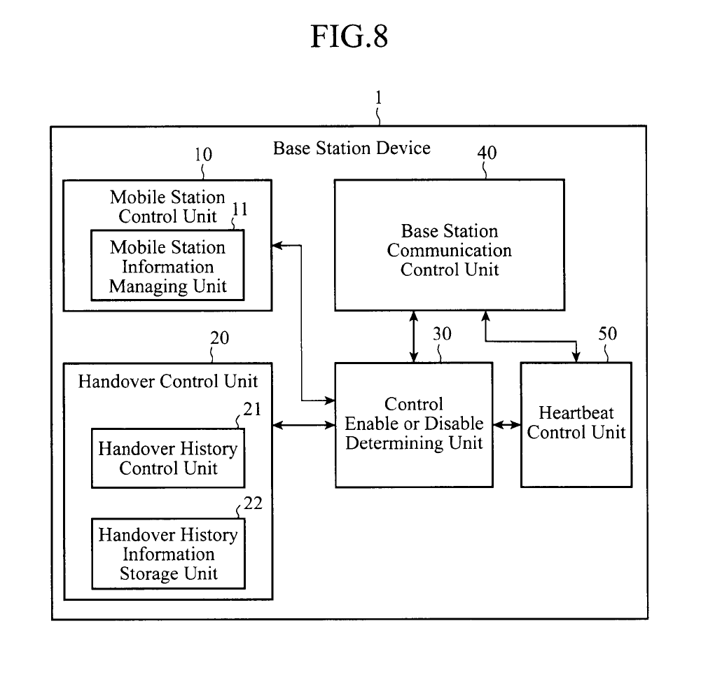

FIG. 8 is a block diagram of a base station device according to Embodiment 3.

In FIG. 8, a heartbeat control unit 50 is a control unit for carrying out heartbeat control with each base station device 1. More specifically, the heartbeat control unit 50 exchanges a heartbeat signal at fixed intervals with another base station device 1. When the heartbeat control unit does not receive any heartbeat signal sent thereto from a base station device 1 which is the communications partner (when a timeout occurs) even if the heartbeat control unit waits for a fixed time interval, the heartbeat control unit determines that the base station device 1 is in a state in which it cannot control the mobile communication device, and commands a control enable or disable determining unit 30 to carry out the processes of step ST22 and subsequent steps of FIG. 7. Because the configuration and operation of the base station device other than the above-mentioned configuration and operation are the same as those of Embodiment 2, the explanation of the configuration and operation will be omitted hereafter.

As mentioned above, the base station device in accordance with Embodiment 3 includes the heartbeat control unit for carrying out heartbeat control with a neighboring base station device, and for, when a timeout occurs in reception of a heart beat signal from one neighboring base station device, determining that allocation of a mobile communication device to the base station device for which the timeout has occurred cannot be made, and, when the heartbeat control unit determines that allocation of the mobile communication device to the base station device cannot be made, the control enable or disable determining unit notifies the base station device that the allocation of the mobile communication device can be made if there is a predetermined amount or more of available resources, the mobile communication device can be positioned within the service area because of increase in radio wave output, and the number of times that a handover from the base station device for which the timeout has occurred has been carried out is smaller than a predetermined value. Therefore, the base station device can easily and surely control the mobile communication device.

Furthermore, because the mobile communication system in accordance with Embodiment 3 includes a plurality of base station devices, and switches control of a moving communication device from a base station device to which no allocation can be made to another base station device which has determined that allocation can be made, even when there is a base station device in the mobile communication system which cannot control the mobile communication device, the mobile communication system can detect the base station device promptly, and surely control the mobile communication device.

### INDUSTRIAL APPLICABILITY

As mentioned above, the present invention relates to a base station device having a configuration of selecting an optimal access point of a mobile communication device by exchanging a control information message with another base station device, and the base station device in accordance with the present invention is suitable for use in a next-generation wireless access system.

1. A base station device comprising:
a handover control unit for, when receiving an inquiry about whether or not allocation of a moving communication device can be made from an arbitrary base station device, recording a number of times that a handover has been carried out for said arbitrary base station device; and
a control enable or disable determining unit for, when receiving said inquiry from another base station device, and said recorded number of times that a handover has been carried out for said other base station device is lower than a predetermined value, determining that allocation can be made.

2. The base station device according to claim 1, wherein the control enable or disable determining unit determines whether or not a throughput can be satisfied when receiving a call setup request from a moving communication device, and, when the throughput can be satisfied, determines that the base station device itself can control the moving communication device, whereas when the throughput cannot be satisfied, the control enable or disable determining unit inquires of a neighboring base station device about whether allocation can be made.

3. The base station device according to claim 1, wherein information showing whether a throughput can be satisfied includes information about available channels.

4. A mobile communication system, wherein the system includes a plurality of base station devices each of which is recited in claim 1, and switches control of a moving communication device from a base station device which has inquired about whether or not allocation can be made to another base station device which has determined that allocation can be made.

5. The base station device according to claim 1, wherein when receiving a notification indicating that the allocation of the mobile communication device cannot be made from the other base station device, the control enable or disable determining unit notifies the other base station device that the allocation of the mobile communication device can be made if there is a predetermined amount or more of available resources, said mobile communication device can be positioned within a service area because of increase in radio wave output, and the number of times that a handover from said other base station has been carried out is lower than the predetermined value.

6. The base station device according to claim 1, wherein the base station device includes a heartbeat control unit for carrying out heartbeat control with a neighboring base station device, and for, when a timeout occurs in reception of a heart beat signal from a neighboring base station device, determining that allocation of the mobile communication device to the base station device for which the timeout has occurred cannot be made, and, when said heartbeat control unit determines that allocation of the mobile communication device to the base station device cannot be made, the control enable or disable determining unit notifies said base station device that allocation of the mobile communication device can be made if there is a predetermined amount or more of available resources, said mobile communication device can be positioned within a service area because of increase in radio wave output, and the number of times that a handover from the base station device for which the timeout has occurred has been carried out is smaller than the predetermined value.

7. A mobile communication system, wherein the system includes a plurality of base station devices each of which is recited in claim 5, and switches control of a moving communication device from a base station device to which no allocation can be made to another base station device which has determined that allocation can be made.
